(19) United States
(12) Patent Application Publication
(10) Pub. No.: US 2026/0243586 A1
(43) Pub. Date: Aug. 20, 2026

(54) SENSOR AND METHOD OF OPERATING A SENSOR

(71) Applicants: Touch Biometrix B.V., Weert (NL); Sharp Display Technology Corporation, Kameyama City (JP)

(72) Inventors: Yamamoto KAORU, Kameyama City (JP); Tanaka KOHEI, Kameyama City (JP); Toru SAKAI, Weert (NL); Wilhelmus VAN LIER, Weert (NL); Henricus DERCKX, Weert (NL)

(21) Appl. No.: 19/164,729

(22) PCT Filed: Mar. 14, 2024
(86) PCT No.: PCT/GB2024/050686

§ 371 Date: Sep. 12, 2025

(30) Foreign Application Priority Data
Mar. 14, 2023 (GB) 2303708.8

(51) Int. Cl. G01D 5/24; G06V 40/13

(52) U.S. Cl. CPC G01D 5/24; G06V 40/1306

(57) ABSTRACT

A capacitive sensor comprising: a plurality of read-out lines; and an array of sensor pixels, wherein each sensor pixel is connected to a read-out line and comprises a capacitive sensing electrode; wherein the sensor is configured to: obtain, from a first read-out line, a signal indicative of a charge on the capacitive sensing electrode of at least one sensor pixel connected to said first read-out line; and maintain a second read-out line at a read-out reference voltage while obtaining said signal from the first read-out line.

### TECHNICAL FIELD

The present disclosure relates to the field of sensors and methods of operating sensors. In particular, the present disclosure may apply to the field of capacitive sensors, such as capacitive biometric skin contact sensors, as well as methods operating such sensors.

### BACKGROUND

PCT publications WO 2020/178605 and WO 2022/043699 disclose different examples of capacitive biometric skin contact sensors. These sensors are operable to obtain capacitance measurements for a sensor array which spans a large area. Based on these capacitance values, biometric data may be obtained for the user contacting the sensor. For example, a difference between ridges and valleys in a user's skin contours may be identified based on the differences in measured capacitance across the sensor array. Such sensors may implement a biometric authentication by comparing an obtained distribution of skin contours to a known distribution of skin contours. For example, the sensor may be a fingerprint sensor which may identify users based on their fingerprints. For both prior art publications, the specific sensor pixel designs disclosed therein are chosen to provide high signal to noise ratios for measurements obtained using those sensor pixels.

The present disclosure aims to reduce noise associated with prior art sensors. In particular, the subject-matter disclosed herein may further increase signal to noise ratios for capacitive sensors such as those of the type disclosed in the above-mentioned PCT publications.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided a capacitive sensor comprising: a plurality of read-out lines; and an array of sensor pixels, wherein each sensor pixel is connected to a read-out line and comprises a capacitive sensing electrode. The sensor is configured to: obtain, from a first read-out line, a signal indicative of a charge on the capacitive sensing electrode of at least one sensor pixel connected to said first read-out line; and maintain a second read-out line at a read-out reference voltage while obtaining said signal from the first read-out line.

In an aspect, there is provided a capacitive sensor comprising: a plurality of supply lines; and an array of sensor pixels, wherein each sensor pixel is connected to a supply line and comprises a capacitive sensing electrode. The sensor is configured to: obtain a signal indicative of a charge on the capacitive sensing electrode of at least one sensor pixel connected to a first supply line; and maintain a second supply line at a supply reference voltage while obtaining said signal from said at least one sensor pixel connected to the first supply line.

In both of the above aspects, a conductive line of the sensor array (read-out line and/or supply line) is maintained at a reference voltage while a signal is obtained from a sensor pixel of the array. As a result, there may be a known value for any capacitive coupling between the signal obtained from the pixel and the relevant conductive line (read-out and/or supply), as the relevant conductive line is at a reference voltage. For example, the signal from the sensor pixel may be a read-out signal carried on a read-out line of the sensor array, and that read-out line may be arranged so that it could couple capacitively with a neighbouring supply line and/or read-out line. By holding the neighbouring supply line and/or read-out line at the reference voltage, the amount of capacitive coupling between the read-out line and its neighbouring line will not be an unknown quantity. In some examples, the neighbouring conductive line(s) may be held at the same voltage as the read-out line from which a read-out signal is being obtained. In which case, there may be no, or minimal, capacitive coupling between that read-out line and its neighbouring conductive line(s).

The two aspects may be provided in combination, with both a supply line and a read-out line being maintained at a respective reference voltage while a signal is obtained from a sensor pixel. For example, the sensor may comprise a plurality of supply lines with each sensor pixel connected to a supply line; the at least one sensor pixel connected to the first read-out line may also be connected to a first supply line; and the sensor may be configured to maintain a second supply line at a supply reference voltage while obtaining the signal from the first read-out line. The supply reference voltage may be the same as the read-out reference voltage. For example, the sensor may be configured to connect supply lines and read-out lines to a reference voltage source (for maintaining both sets of lines at a reference voltage).

Each read-out line may have a corresponding supply line connected to the same sensor pixels as said read-out line. The sensor pixels may be arranged into different collections of sensor pixels, where each collection of sensor pixels has its own supply line and/or read-out line. The supply/read-out line may be connected to each sensor pixel in the collection. For example, the sensor array may comprise a plurality of rows of sensor pixels and a plurality of columns of sensor pixels. Each collection of sensor pixels (e.g. each column) may have its own supply line and read-out line. The sensor may be configured to activate some of the collections (e.g. columns) of the sensor array while inactivating other (e.g. the remaining) collections (e.g. columns) of the sensor array. Activated collections (e.g. columns) may contain at least one sensor pixel from which a signal indicative of charge on its capacitive sensing electrode is obtained. The supply line for each activated collection (e.g. column) may be connected to a supply voltage source. The read-out line for each activated collection (e.g. column) may be connected to a processing channel of read-out input circuitry of the sensor. The supply line for each inactivated collection (e.g. column) may be connected to a (supply) reference voltage source. The read-out line for each inactivated collection (e.g. column) may be connected to a (read-out) reference voltage source. For example, inactivated supply lines and their associated inactivated read-out lines may be connected to a common reference voltage source. Maintaining a conductive line (e.g. read-out or supply) at a reference voltage may while a read-out signal is obtained may comprise connecting said conductive line to a reference voltage source, e.g. so that said conductive line is connected to the reference voltage source while a read-out signal is being obtained.

In other words, the sensor may be configured to maintain any inactivated supply lines and/or read-out lines of the sensor array at a reference voltage. The sensor may be configured to maintain the inactivated supply lines and/or read-out lines of the sensor array at a reference voltage while read-out signals are obtained from sensor pixels connected to activated supply lines and/or read-out lines. The sensor is configured to control operation so that some of the read-out/supply lines of the sensor array will be activated and some will be inactivated. As described above, any capacitive coupling between activated read-out lines and inactivated supply/read-out lines may be known (e.g. it may be minimal, such as zero), as the inactivated lines will be maintained at a known reference voltage (e.g. which may the same as, or close to, a voltage of the read-out signal processing circuitry of the sensor).

The first read-out line and the second read-out line may be switchably connected to a single channel of read-out circuitry of the sensor. Three or more read-out lines may be switchably connected to a single channel of read-out circuitry of the sensor. The sensor may be configured to multiplex signals from said two or more read-out lines onto the single channel. The single channel may be a signal processing channel of read-out circuitry of the sensor. The read-out circuitry may be configured to obtain a digital indication of the charge stored on the capacitive sensing electrode based on the read-out signal provided to the processing channel of the read-out circuitry. The read-out lines may be arranged in groups, where each group containing a plurality of read-out lines has one associated processing channel. The sensor may be configured to connect only one of the read-out lines in the group to the processing channel at a time. The sensor is configured to select which read-out line is connected to the processing channel at any one time. The sensor may be configured to only activate one read-out line (and associated supply line) per group of read-out lines. The sensor may connect the activated read-out line in the group to the processing channel. The sensor may connect the remaining inactivated read-out line(s) in the group to a read-out reference voltage source.

The sensor may be configured to selectively connect each read-out line to either: (i) a read-out reference voltage source for maintaining said read-out line at the read-out reference voltage, or (ii) read-out circuitry of the sensor for processing signals received therefrom. The sensor may be configured to selectively connect each supply line to either: (i) a supply reference voltage source for maintaining said supply line at the supply reference voltage, or (ii) a pixel supply voltage source for providing electrical energy to sensor pixels connected to said supply line. The read-out reference voltage source and the supply reference voltage source may be the same (e.g. a common reference voltage source). The sensor may comprise a plurality of select lines, wherein each select line is associated with a read-out line and a corresponding supply line. The sensor may be configured to control application of select signals to each select line to control connections of the read-out line and supply line associated with said select line. Applying a select signal to a select line associated with the first read-out line and the first supply line may connect: (i) the first read-out line to the read-out circuitry, and (ii) the first supply line to the pixel supply voltage source. Applying a select signal to a select line associated with the second read-out line and the second supply line may connect: (i) the second read-out line to the read-out reference voltage source, and (ii) the second supply line to the supply reference voltage source.

In other words, the sensor may be configured to selectively activate and inactive read-out lines and supply lines by applying a signal to a relevant select line. For example, each supply line and its associated read-out line may have an associated select line. The sensor may be arranged so that application of a select signal (e.g. a voltage) to a select line may activate any supply and read-out lines associated with that select line. Application of the select signal to that select line may inactivate any supply and read-out lines which are not associated with that select line. Each select line may be associated with one supply line and one read-out line per group of read-out lines. Application of a select signal to a select line may activate one read-out line (and associated supply line) per group of read-out lines (and e.g. inactivate the remaining supply/read-out lines within each group).

The first read-out line may be adjacent to the second read-out line. The first supply line may be adjacent to the second supply line. The read-out reference voltage may be selected to correspond to a voltage of read-out circuitry of the sensor. The read-out reference voltage may be the same as or close to the voltage of the read-out circuitry (e.g. it may be within a threshold range of the voltage of the read-out circuitry, such as within 1 V, or 0.5 V or 0.25 V or 0.1 V). The read-out reference voltage for the second line may be the same as a voltage for the first read-out line. The sensor array may comprise a plurality of scan lines. Each sensor pixel may be connected to a scan line for receiving scanning signals. Scanning signals may be applied for activating sensor pixels. For example, each activated sensor pixel may receive a scanning signal via the scan line to which it is connected, a supply voltage from the supply line to which it is connected, and output a read-out signal to a read-out line to which it is connected, where that read-out line is connected to a processing channel of the read-out circuitry of the sensor. The capacitive sensor may comprise a capacitive touch sensor.

The sensor may comprise an array of sensor pixels, where each sensor pixel includes one or more thin film transistors (‘TFTs’) and a capacitive sensing electrode. The sensor pixels may be arranged in an active-matrix array in which the sensor may be operable to address each pixel by applying a scanning signal to that pixel. Each pixel being addressed may also receive a supply voltage from a supply line. Each pixel being addressed may output a read-out signal to a read-out line. For each sensor pixel, the read-out signal may be indicative of the proximity of a conductive body to be sensed to the capacitive sensing electrode of that sensor pixel. The sensor may comprise read-out circuitry configured to process said read-out signals.

For example, each sensor pixel may include at least one TFT which controls the read-out signals from that sensor. This may comprise a ‘sense TFT’ arranged for outputting read-out signals to a read-out line. When each pixel is addressed by a scanning signal (along a scan line connected to that pixel) and receives a supply voltage (from a supply line connected to that pixel), the sense TFT may output a read-out signal to the read-out line to which it is connected. The capacitive sensing electrode may be coupled to a gate region of the sense TFT, and so a magnitude of the read-out signal from the sense TFT to the read-out line may be influenced by the effective capacitance of the capacitive sensing electrode (i.e. which may thus be indicative of the proximity of the conductive body to be sensed to that capacitive sensing electrode). The sensor may be configured to perform this process iteratively for different sensor pixels so that a read-out signal has been obtained for each sensor pixel in the array.

For capacitive biometric sensors, the number of sensor pixels per unit area may be relatively high. For example, such sensors may have a spatial resolution of somewhere between 300 and 500 pixels per inch. In which case, as will be appreciated, the conductive lines of the sensor array may be arranged in very close proximity to each other. In which case, capacitive coupling between adjacent lines may not be a negligible quantity. As such, by fixing adjacent lines as disclosed herein, issues associated with this capacitive coupling may be negated.

In an aspect, there is provided a method of operating a capacitive sensor, wherein the sensor comprises: (i) a plurality of read-out lines, and (ii) an array of sensor pixels, wherein each sensor pixel is connected to a read-out line and comprises a capacitive sensing electrode, the method comprising: obtaining, from a first read-out line, a signal indicative of a charge on the capacitive sensing electrode of at least one sensor pixel connected to said first read-out line; and maintaining a second read-out line at a read-out reference voltage while obtaining said signal from the first read-out line.

In an aspect, there is provided a method of operating a capacitive sensor, wherein the sensor comprises: (i) a plurality of supply lines, and (ii) an array of sensor pixels, wherein each sensor pixel is connected to a supply line and comprises a capacitive sensing electrode, the method comprising: obtaining a signal indicative of a charge on the capacitive sensing electrode of at least one sensor pixel connected to a first supply line; and maintaining a second supply line at a supply reference voltage while obtaining said signal from said at least one sensor pixel connected to the first supply line.

In an aspect, there is provided a method of operating a capacitive sensor, wherein the sensor comprises: (i) a plurality of read-out lines, (ii) a plurality of supply lines, and (iii) an array of sensor pixels, wherein each sensor pixel is connected to a read-out line and a supply line and comprises a capacitive sensing electrode, the method comprising: obtaining, from a first read-out line, a signal indicative of a charge on the capacitive sensing electrode of at least one sensor pixel connected to said first read-out line and a first supply line; maintaining a second read-out line at a read-out reference voltage while obtaining said signal from the first read-out line; and maintaining a second supply line at a supply reference voltage while obtaining said signal from the first read-out line.

Methods may comprise connecting the first read-out line to read-out circuitry and connecting the second read-out line to a read-out reference voltage source. Methods may comprise connecting the first supply line to a pixel supply voltage source and the second supply line to a supply reference voltage source. Connecting both: (i) the second read-out line to the read-out reference voltage source, and (ii) the second supply line to the supply reference voltage source, may comprise connecting the second read-out line and the second supply line to the same reference voltage source. Methods may comprise controlling application of select signals to a plurality of select lines to control connections of the read-out lines and/or the supply lines.

Aspects of the present disclosure may provide one or more computer program products comprising computer program instructions configured to program a capacitive sensor to implement any of the methods disclosed herein.

### FIGURES

Some examples of the present disclosure will now be described, by way of example only, with reference to the figures, in which:

FIG. 1a is a schematic diagram illustrating a capacitive sensor.

FIG. 1b is a schematic diagram illustrating operation of the capacitive sensor of FIG. 1a.

FIG. 2a is a schematic diagram illustrating a capacitive sensor.

FIG. 2b is a schematic diagram illustrating operation of the capacitive sensor of FIG. 2a.

FIG. 3a is a schematic diagram illustrating a capacitive sensor.

FIG. 3b is a schematic diagram illustrating operation of the capacitive sensor of FIG. 3a.

In the drawings like reference numerals are used to indicate like elements.

### SPECIFIC DESCRIPTION

Embodiments of the present disclosure are directed to capacitive sensors which are designed to reduce the influence of undesirable effects associated with parasitic capacitive coupling of different components within the sensor. Sensors of the present disclosure are formed of an array of sensor pixels, with each sensor pixel being connected to a plurality of different electrically conductive lines. For instance, each sensor pixel may be connected to a supply line for receiving a supply voltage from that supply line (when activated) and a read-out line for outputting a read-out voltage to that read-out line (when activated). In sensors of the present disclosure, supply lines and/or read-out lines which are currently inactivated (i.e. which are not connected to any activated pixels) may be fixed at a reference voltage. These fixed reference voltage lines may therefore provide a constant and known parasitic capacitive coupling effect with active lines. In so doing, additional and unquantifiable sources of noise may be removed from read-out signals from activated pixels.

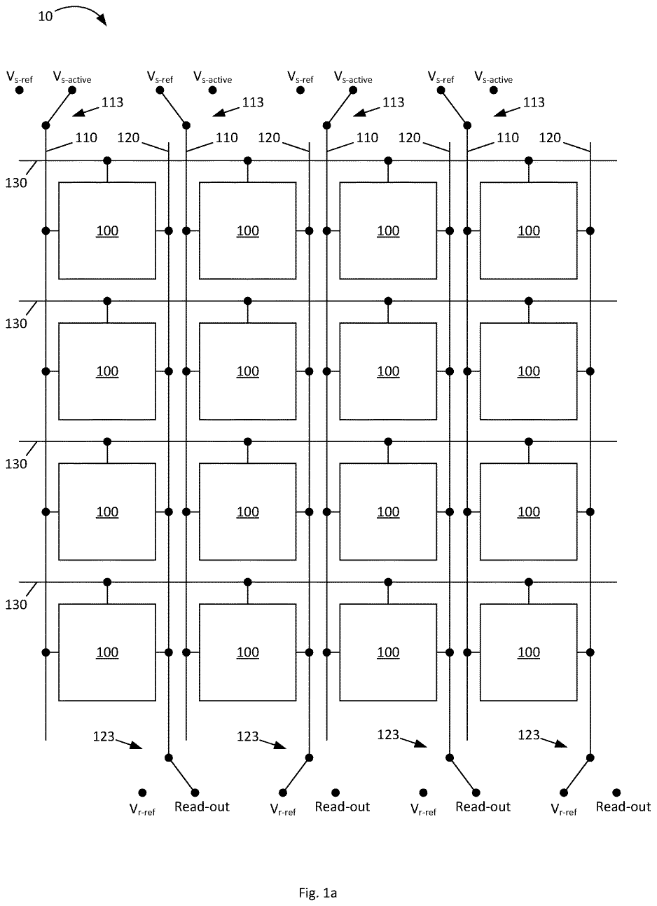

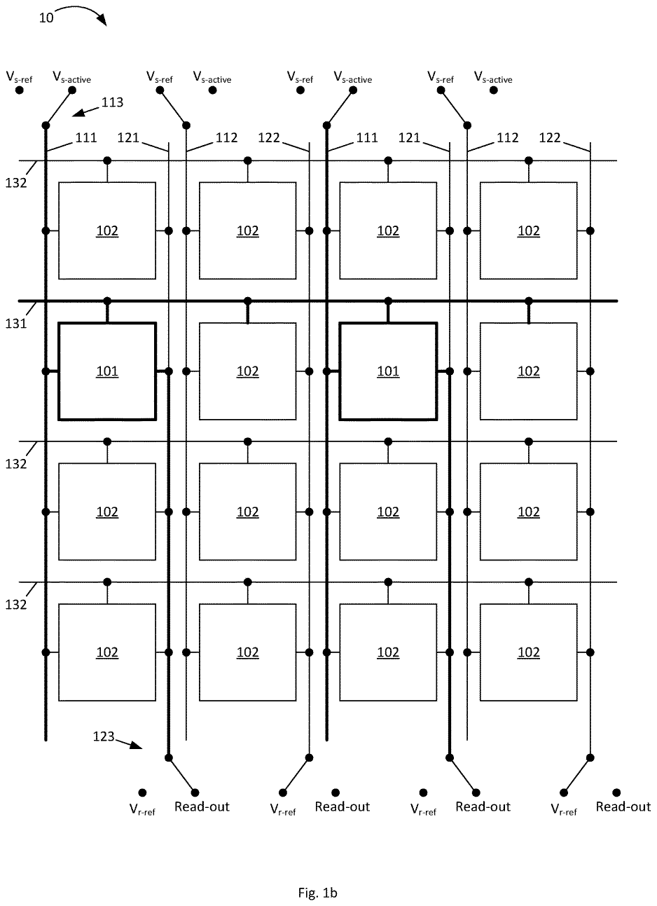

Several different examples of capacitive sensors will now be described with reference to FIGS. 1a to 3b. For each of these examples, the disclosure primarily relates to arrangements for connecting inactivated lines to a reference voltage and for connecting active lines to the relevant circuitry required for obtaining measurements from activated pixels. It will be appreciated in the context of the present disclosure that the particular arrangement for each individual sensor pixel should not be considered limiting. For example, any pixel design could be used in which a scanning signal is used for activating each pixels, and where activated pixels receive a supply voltage and output read-out signals therefrom.

A first example of a capacitive sensor will now be described with reference to FIGS. 1a and 1b. FIG. 1a shows the arrangement of the sensor, and FIG. 1b shows an example of the sensor in operation. Black circular dots illustrate electrical connections.

FIG. 1a shows a sensor 10. The sensor 10 is formed of an array of sensor pixels 100. The sensor 10 also includes a plurality of different conductive lines across the sensor array. The conductive lines include: a plurality of supply lines 110, a plurality of read-out lines 120 and a plurality of scan lines 130.

Each of the supply lines 110 may be connected to either a supply reference voltage (shown as ‘V_{s-ref}’) or an active supply voltage (shown as ‘V_{s-active}’). To illustrate this functionality, each supply line 110 is shown with an associated supply line switch 113 (e.g. for switching between the two supply line connections). Each of the read-out lines 120 may be connected to either a read-out reference voltage (shown as ‘V_{r-ref}’) or to read-out circuitry of the sensor 10 (shown as ‘Read-out’). To illustrate this functionality, each read-out line 120 is shown with an associated read-out line switch 123 (e.g. for switching between the two read-out line connections).

The sensor 10 is formed of an array of sensor pixels 100. The array comprises a plurality of rows of sensor pixels 100 and a plurality of columns of sensor pixels 100. Although FIG. 1a shows a 4×4 grid, it will be appreciated that the array may be substantially larger. The conductive lines of the conform to the pattern of the sensor pixels 100 within the sensor array.

As shown in FIG. 1a, each scan line 130 extends horizontally across the array. Each scan line 130 is associated with sensor pixels 100 in one row of the array. Each scan line 130 may be connected to every sensor pixel 100 in its respective row of the array. The scan lines 130 run substantially parallel to each other (e.g. each scan line 130 may be parallel with its adjacent scan line(s) 130). Each scan line 130 is connected to a source for providing scanning signals.

As shown in FIG. 1a, each supply line 110 extends vertically across the array. Each supply line 110 is associated with sensor pixels 100 in one column of the array. Each supply line 110 may be connected to every pixel 100 in its respective column of the array. The supply lines 110 may run substantially parallel to each other (e.g. each supply line 110 may be parallel with its adjacent supply line(s) 110). Each supply line 110 is switchably connected to either a supply reference voltage source or a supply active voltage source.

As shown in FIG. 1a, each read-out line 120 extends vertically across the array. Each read-out line 120 is associated with sensor pixels 100 in one column of the array. Each read-out line 120 may be connected to every pixel 100 in its respective column of the array. The read-out lines 120 may run substantially parallel to each other (e.g. each read-out line 120 may be parallel with its adjacent read-out line(s) 120). The read-out lines 120 may run substantially parallel to the supply lines 110 (e.g. each read-out line 120 may be parallel with its adjacent supply line(s) 110). The read-out lines 120 and the supply lines 110 may run substantially perpendicular (e.g. perpendicular) to the scan lines 130. Each read-out line 120 is switchably connected to either a read-out reference voltage source or to read-out circuitry of the sensor 10.

Each sensor pixel 100 is connected to a scan line 130, a supply line 110 and a read-out line 120. In FIG. 1a, each sensor pixel 100 is connected to one of each of those lines, but they may be connected to more. For example, each sensor pixel 100 may be connected to two (or more) scan lines 130. Each column of sensor pixels 100 has a supply line 110 and a read-out line 120 for that column. Each supply line 110 therefore has a corresponding read-out line 120 associated with the same sensor pixels 100. Each supply line 110, and its corresponding read-out line 120, will either be in active state in which one or more sensor pixels 100 in that column are activated (i.e. to provide a read-out signal therefrom), or in an inactivated state in which no sensor pixels 100 in that column are activated. At least some of the supply lines 110 and/or read-out lines 120 may be located adjacent to a conductive line associated with a different column of sensor pixels 100. For example, and as shown in FIG. 1a, the read-out line 120 from each column is located close to, and parallel with, a supply line 110 for the next column.

Each sensor pixel 100 comprises a capacitive sensing electrode. Each sensor pixel 100 may include one or more TFTs for controlling the output of read-out signals from the sensor pixel. For example, the capacitive sensing electrode, the scan line 130 and the supply line 110 for each pixel 100 may be connected (directly or indirectly) to a TFT of that sensor pixel. That TFT may also be connected to the read-out line 120 for that pixel 100 (e.g. so that a conductive path through the TFT may connect the supply line 110 to the read-out line 120). Operation of the scan line 130 and the amount of charge stored on the capacitive sensing electrode may control current flow through the TFT and to the read-out line 120.

The sensor 10 is configured to selectively connect each supply line 110 to either the supply reference voltage source or the supply active voltage source. For example, the sensor 10 may comprise one or more switches (e.g. supply line switches 113) which are operable to select whether each supply line 110 is connected to the supply reference voltage source or the supply active voltage source. The sensor 10 is configured to selectively connect each read-out line 120 to either the read-out reference voltage source or to the read-out circuitry of the sensor 10. Each read-out line 120 may be switchably connectable to a processing channel of the read-out processing circuitry of the sensor 10. For example, the sensor 10 may comprise one or more switches (e.g. read-out line switches 123) which are operable to select whether each read-out line 120 is connected to the read-out reference voltage source or to the read-out circuitry of the sensor 10.

The sensor 10 is configured to control operation so that one or more of the columns of sensor pixels 100 are activated (i.e. they do contain activated pixels) and one or more of the columns of sensor pixels 100 are inactivated (i.e. they do not contain any activated pixels).

For an activated column, at least one sensor pixel 100 within that column will be activated. To activate a sensor pixel 100 within that column, the sensor 10 is configured to provide a scanning signal to the scan line 130 connected to that pixel 100 (e.g. to provide the scanning signal to the scan line 130 associated with the row of pixels 100 which contains the pixel 100 to be activated in that column), and to provide an active supply voltage to that pixel 100 (e.g. to provide the active supply voltage to the supply line 110 associated with that column of pixels 100). For this, the sensor 10 may be configured to selectively activate the relevant scan lines 130 and supply lines 110. For example, the sensor 10 may be configured to connect the scan line 130 to a voltage source to provide the scanning signal to that scan line 130. Likewise, the sensor 10 is configured to connect the supply line 110 to the supply active voltage source to provide the active supply voltage to that supply line 110 (and thus to the activated sensor pixel within the column of sensor pixels 100). Activating the relevant scan lines 130 may comprise applying a signal, such as a voltage signal, to that scan line which will cause a TFT of the sensor pixel 100 to be sufficiently activated for outputting a read-out signal. For example, in an NMOS arrangement, this may comprise applying a ‘high’ voltage to the scan line 130 (and thus to the sensor pixel 100). However, it will be appreciated that other arrangements could be used, e.g. using PMOS.

Each activated sensor pixel is configured to output a read-out signal to the read-out line 120 connected to that sensor pixel. The sensor 10 is configured so that each activated read-out line (i.e. a read-out line 120 which is connected to an activated pixel) is connected to the read-out signal processing circuitry of the sensor 10. As such, each activated read-out line will connect an activated sensor pixel to the read-out signal processing circuitry of the sensor 10. The read-out signal processing circuitry is configured to process received read-out signals from activated pixels.

In other words, for each column containing an activated sensor pixel (i.e. for each activated column), the sensor 10 is configured to connect the associated supply line 110 (the supply line 110 for that column) to the supply active voltage source, and to connect the associated read-out line 120 (the read-out line 120 for that column) to the read-out circuitry of the sensor 10. The sensor 10 is configured to select which sensor pixel 100 within that column is activated by applying a scanning signal to the scan line 130 connected to said sensor pixel.

For an inactivated column, no sensor pixels 100 within that column will be activated (they will all be inactivated). The sensor 10 is configured to set at least one of the supply line 110 and the read-out line 120 for that inactivated column to a reference voltage. The sensor 10 may be configured to set both: (i) the supply line 110 to a supply line reference voltage, and (ii) the read-out line 120 to a read-out reference voltage. To set the supply line 110 to a supply line reference voltage, the sensor 10 is configured to connect the supply line 110 to the supply reference voltage source (e.g. to set said supply line 110 to V_{s-ref}). To set the read-out line 120 to a read-out reference voltage, the sensor 10 is configured to connect the read-out line 120 to the read-out reference voltage source (e.g. to set said read-out line 120 to V_{r-ref}). As such, the supply line 110 and the read-out line 120 for that column may each be at a reference voltage, and the read-out line 120 will be disconnected from the read-out circuitry of the sensor 10. No read-out signals will be obtained from that column of pixels 100. Due to the voltage of the supply line 110 and/or read-out line 120 being fixed for this inactivated column, it may be accurately determined what, if any, parasitic capacitive coupling there will be between these lines and any neighbouring activated lines.

In other words, for each column not containing an activated sensor pixel (i.e. for each inactivated column), the sensor 10 is configured to connect the associated supply line 110 (the supply line 110 for that column) to the supply reference voltage source, and to connect the associated read-out line 120 (the read-out line 120 for that column) to the read-out reference voltage source. The supply line 110 will thus be held at V_{s-ref} and the read-out line 120 will be V_{r-ref}, while any read-out signals are obtained from activated pixels 100 in other columns of the sensor array. Any sensor pixels 100 in an inactivated column which are connected to an activated scan line will not be able to output any read-out signals, and so will remain inactivated.

The supply reference voltage (V_{s-ref}) may be the same as the read-out reference voltage (V_{r-ref}). The supply line 110 and the read-out line 120 for an inactivated column may be connected to a common reference voltage source. For example, V_{s-ref} and V_{r-ref}, as shown in FIG. 1a, may arise from a common voltage source (e.g. they may be the same voltage source). The reference voltage (for one or both of the supply lines 110 and the read-out lines 120) may be selected based on a voltage of the read-out circuitry of the sensor 10. For example, the reference voltage may be selected to correspond to this voltage of the read-out circuitry, e.g. so that the reference voltage is at, or close to, the read-out circuitry voltage. The reference voltage may be within a threshold voltage of the read-out circuitry voltage. For example, the reference voltage may be within 1 Volt of the read-out circuitry voltage, or e.g. within 0.5 V or 0.25 V.

By using a reference voltage for inactivated lines which is at, or close to, the read-out circuitry voltage, the inactivated lines will be at a similar voltage to the activated read-out lines. As such, the capacitive coupling effect between an activated read-out line and its adjacent inactivated line(s) will be significantly reduced. As will be appreciated, if an activated read-out line is at an approximately similar voltage to its neighbouring inactivated supply and/or read-out lines, the capacitive coupling therebetween will be small (if the voltages are the same then any capacitive coupling will be minimal). Also, by maintaining inactivated read-out lines at a voltage at, or close to, a voltage of the read-out circuitry, this may reduce the need to repeatedly charge/discharge read-out lines so that they are at the read-out circuitry voltage once activated. In turn, this may reduce overall power consumption for the sensor 10.

For activated pixels, the sensor 10 is configured to obtain read-out signals in the form of current signals. The read-out signal processing circuitry may comprise one or more integrators. The circuitry may be configured to obtain an indication (e.g. a digital representation) of an amount of charge stored on the capacitive sensing electrode for each sensor pixel 100 (e.g. an indication of the proximity to that capacitive sensing electrode of a conductive body to be sensed).

The read-out circuitry of the sensor 10 may comprise a plurality of processing channels, each of which is arranged for receiving read-out signals and obtaining relevant indications therefrom. Sensors of the present disclosure may be configured to multiplex read-out signals from each of a plurality of different read-out lines 120 into a single processing channel of the read-out circuitry. In other words, the sensor 10 may be configured to selectively connect one out of a plurality of different read-out lines 120 to a processing channel of the read-out circuitry. By doing so, the total number of such processing channels needed for the read-out circuitry will be reduced (thus reducing the cost and complexity required to implement said read-out circuitry).

For example, the sensor 10 may be arranged so that each processing channel of the read-out circuitry may be associated with a plurality of different read-out lines 120. The sensor 10 may be configured to selectively connect each of those read-out lines 120 to said processing channel. The sensor 10 may be configured to only connect one read-out line 120 at a time to said processing channel. Each read-out line 120 may only be connectable to one processing channel. The sensor 10 may be configured to only connect an activated read-out line to the processing channel. For example, for each group of read-out lines 120 associated with one processing channel of the read-out circuitry, the sensor 10 may be configured to sequentially connect each read-out line 120 to the processing channel (as each read-out line 120 is sequentially activated). In other words, for each group of read-out lines 120 associated with a single processing channel of the read-out circuitry, the sensor 10 may be configured to only activate one of those read-out lines 120 at any one time, with the remaining read-out lines 120 being inactivated. For each such group of read-out lines 120, when one read-out line is activated (and so too is its associated supply line 110), the remaining lines in the group will be inactivated.

The sensor 10 is configured to obtain read-out signals indicative of a charge on the capacitive sensing electrode of each of one or more activated sensor pixels. For this, the sensor 10 is configured to apply a supply signal to the (activated) supply line 110 connected to the activated sensor pixel and to connect the (activated) read-out line connected to that activated sensor pixel to the processing channel of the read-out circuitry. All other read-out lines associated with that processing channel will be inactivated (i.e. connected to the reference voltage), as will the supply lines 110 associated with those read-out lines. In other words, the sensor 10 is configured to obtain, from a first read-out line, a signal indicative of a charge on the capacitive sensing electrode of at least one sensor pixel 100 connected to said first read-out line and to a first supply line, while maintaining a second supply line at a supply reference voltage and a second read-out line at a read-out reference voltage while obtaining said signal from said at least one sensor pixel 100 connected to the first supply line and the first read-out line.

One example step of a method of operating this sensor 10 of FIG. 1a will now be described with reference to FIG. 1b.

FIG. 1b shows the same sensor 10 as FIG. 1a. Additionally, thick black lines are used to show which conductive lines and sensor pixels are activated. Also, activated and inactivated lines are now indicated in FIG. 1b. Shown, the sensor array of FIG. 1b has two activated supply lines 111, two inactivated supply lines 112, two activated read-out lines 121, two inactivated read-out lines 122, one activated scan line 131 and three inactivated scan lines 132. Also indicated in FIG. 1b are activated sensor pixels 101 and inactivated sensor pixels 102.

As described above, the sensor 10 may be configured to operate with only a subset of the sensor pixels 100 activated at any one time. That is, the sensor array is operated with one or more activated sensor pixels 101 and one or more non-activated sensor pixels 102 at any one time. The sensor 10 may operate with activated sensor pixels 101 in some, but not all, of the columns of the sensor array. For each group of read-out lines 120 which are associated with the same single processing channel of the read-out circuitry, only one of these columns will be activated at any one time. Typically, the activated pixels 101 may only be in one row of the sensor array at a time.

In the example illustrated in FIG. 1b, the sensor 10 is configured to activate one pixel 100 in every other column, with all of the activated pixels 101 in one row. As shown in FIG. 1b, there is one activated scan line 131. This activated scan line 131 is connected to all of the sensor pixels 100 in that row (the second row shown in FIG. 1b). There are two activated supply lines 111. Each supply line is connected to all of the sensor pixels 100 in their respective columns (the first and third columns shown in FIG. 1b). There are two activated read-out lines 121. The two activated read-out lines 121 correspond to the two activated supply lines 111. The two activated read-out lines 121 are also connected to all of the sensor pixels in their respective columns (the first and the third columns shown in FIG. 1b).

Each activated supply line 111 is connected to the supply active voltage source, and each inactivated supply line 112 is connected to the supply reference voltage source. As such, the activated supply lines 111 (first and third columns) are at V_{s-active} and the inactivated supply lines 112 (second and fourth columns) are at V_{s-ref}. Each activated read-out line 121 is connected to the read-out circuitry (e.g. to a respective processing channel thereof), and each inactivated read-out line 122 is connected to the read-out reference voltage source. As such, the activated read-out lines 121 (first and third columns) are arranged to provide read-out signals to the read-out circuitry and the inactivated read-out lines 122 (second and fourth columns) are at V_{r-ref}. The activated scan line 131 will have a signal applied thereto for activation. For example, for the case of NMOS, this may comprise driving the activated scan line 131 to a higher voltage (e.g. at a scanning voltage) than the inactivated scan lines 132. However, it will be appreciated in the context of the present disclosure that any suitable activation signal (e.g. scanning voltage) may be applied to the activated read-out lines 122. That activation signal will be different to any signal applied to an inactivated line 132 (no signal may be applied to the inactivated lines 132).

The activated sensor pixels 101 are those which are connected to both the activated scan line 131 and an activated supply line 111. In FIG. 1b, these are the second row sensor pixels in the first and third columns. Inactivated sensor pixels 102 are those which will not output a read-out signal to the read-out circuitry.

In operation, a scanning signal is applied to the activated scan line 131. The scanning signal is provided to each sensor pixel 100 in the row associated with that scan line (as the scan line is connected to every sensor pixel 100 in that row). A supply voltage V_{s-active} is provided to the activated supply lines 111. The supply voltage V_{s-active} is provided to each sensor pixel 100 in the columns associated with the activated supply lines 111 (as the supply lines are connected to every sensor pixel 100 in their respective columns). The activated sensor pixels 101 are the ones which receive both the scanning signal and the supply voltage V_{s-active}. The inactivated sensor pixels 102 are the ones which only receive one or neither of the scanning signal and the supply voltage V_{s-active}.

For each activated sensor pixel, applying the scanning signal to that sensor pixel 100 may act to switch on one or more TFTs of that sensor pixel. For each activated sensor pixel, applying the supply voltage V_{s-active} to that sensor pixel 100 may enable one or more TFTs of that sensor pixel 100 to output electrical signals (if those one or more TFTs are activated). For example, each sensor pixel 100 may be arranged so that a TFT of the sensor pixel 100 is connected to the capacitive sensing electrode and connected to receive the scanning signal. That TFT may provide a variable conduction path between the scanning line (and thus the supply voltage V_{s-active}) and the read-out line, where the amount of current permitted to flow to the read-out line is indicative of the charge stored on the capacitive sensing electrode. As such, for a sensor pixel 100 which receives both the scanning signal and the supply voltage V_{s-active}, that sensor pixel 100 may output a read-out signal indicative of the charge stored on its capacitive sensing electrode. The read-out line connected to an activated sensor pixel (i.e. an activated read-out line 121) is also connected to the read-out circuitry of the sensor 10. The read-out signal from the activated sensor pixel is thus provided to the processing channel of the read-out circuitry for processing thereof.

This conduction sequence is shown in FIG. 1b, where the two activated sensor pixels 101 are connected to both the activated scan line 131 and an activated supply line 111, and those pixels 101 output a read-out signal to an activated read-out line 121, which is connected to the read-out circuitry (these different activated lines are shown in bold in FIG. 1b).

For the remaining sensor pixels 102, each sensor pixel 102 is connected to an inactivated scan line 132 and/or inactivated supply/read-out lines.

For those inactivated sensor pixels 102 not connected to an activated scan line 131, the sensor pixel will not be activated by the scanning signal, and so no read-out signal would be provided from said sensor pixel. For inactivated sensor pixels 102 not connected to activated supply and read-out lines, the supply and read-out lines to which they are connected will be fixed at a reference voltage. Therefore, no read-out signal could be output, as the supply and read-out lines connected to each inactivated sensor pixel 102 are at the same voltage.

As such, in operation, any inactivated supply lines 112 and read-out lines 122 will be at a reference voltage. Those lines may remain at a fixed, constant, reference voltage while read-out signals are obtained from the activated sensor pixels 101. Any inactivated sensor pixels 102 in activated columns may not output read-out signals to their respective read-out processing channels, as they are not activated by a scan line (i.e. they do not receive a scanning signal). In other words, the only sensor pixels which contribute any currents/voltages to conductive lines of the sensor array are the activated sensor pixels 101. This arrangement may therefore reduce noise associated with parasitic coupling between different conductive lines/sensor pixels within the array.

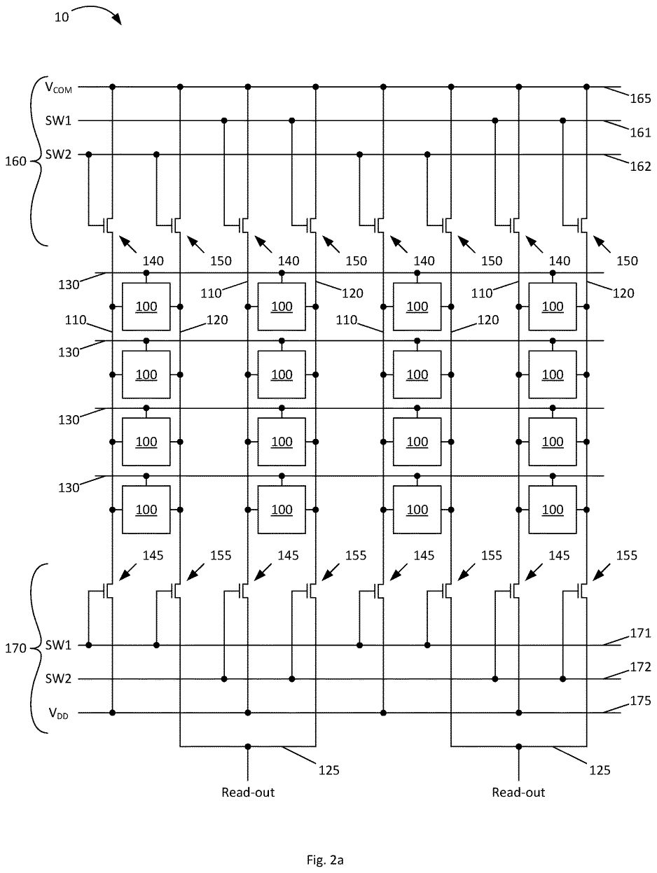

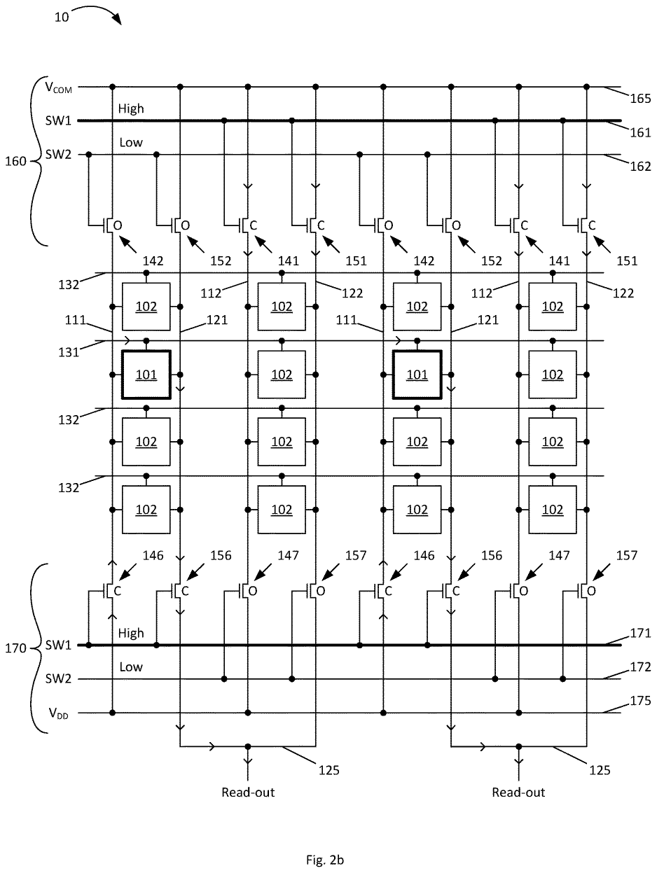

Another example of a capacitive sensor will now be described with reference to FIGS. 2a and 2b.

FIG. 2a shows a sensor 10, which is similar to that described above in relation to FIGS. 1a and 1b. The sensor 10 shown FIG. 2a includes additional circuitry to provide the relevant selective connections for the supply lines 110 and the read-out lines 120. For FIG. 2a, a common reference voltage (V_{COM}) is used. As compared to FIG. 1a, in FIG. 2a, the common reference voltage V_{COM} provides both the supply reference voltage (V_{s-ref} in FIG. 1a) and the read-out reference voltage (V_{r-ref} in FIG. 1a). A supply voltage (V_{DD}) is used for activated supply lines, and activated read-out lines are connected to the read-out circuit. As compared to FIG. 1a, in FIG. 2a, the supply voltage V_{DD} provides the active supply voltage V_{s-active}.

As with the sensor 10 of FIG. 1a, the sensor 10 of FIG. 2a includes a plurality of sensor pixels 100, supply lines 110, read-out lines 120 and scan lines 130. The sensor 10 also includes inactivate connection circuitry 160 and activate connection circuitry 170. The inactivate connection circuitry 160 is for connecting the supply and read-out lines of inactivated columns to the reference voltage (V_{COM}), and the activate connection circuitry 170 is for connecting the supply and read-out lines of activated columns to the supply voltage (V_{DD}) and the processing channel of the read-out circuitry, respectively.

The inactivate connection circuitry 160 is formed of a plurality of conductive lines and a plurality of associated switches. The conductive lines may comprise control/signal lines for the sensor array. Said conductive lines are connected to the associated switches so that application of electrical signals along the conductive lines will selectively open or close said switches. The inactivate connection circuitry 160 comprises a first inactivate select line 161, a second inactivate select line 162 and a reference voltage line 165. The inactivate connection circuitry 160 also comprises an inactivate supply switch 140 for each supply line 110 and an inactivate read-out switch 150 for each read-out line 120.

The activate connection circuitry 170 is formed of a plurality of conductive lines and a plurality of associated switches. Said conductive lines are connected to the associated switches so that application of electrical signals along the conductive lines will selectively open or close said switches. The activate connection circuitry 170 comprises a first activate select line 171, a second activate select line 172 and a supply voltage line 175. The activate connection circuitry 170 also comprises an activate supply switch 145 for each supply line 110 and an activate read-out switch 155 for each read-out line 120. The activate connection circuitry 170 comprises a read-out connection channel 125.

The arrangement of the sensor pixels 100, the scan lines 130, the supply lines 110 and the read-out lines 120 across the sensor array is the same as in FIG. 1a. That is, each read-out line 120 has a corresponding supply line 110 which is connected to the same column of sensor pixels 100.

Each supply line 110 is connected to both the inactivate connection circuitry 160 and the activate connection circuitry 170. Each supply line 110 is connected to the reference voltage line 165 via an inactivate supply switch 140. Each inactivate supply switch 140 is also connected to one of the inactivate select lines. As will be described in more detail below, the sensor 10 is configured to selectively open/close each inactivate supply switch 140 by selectively applying an electrical signal to the inactivate select line to which said inactivate supply switch 140 is connected (thereby to selectively set the supply line 110 to V_{COM}). As shown in FIG. 2a, each switch may be provided by a transistor, such as a TFT. A control terminal of each inactivate supply switch 140 (e.g. a gate region of the TFT) is connected to one of the inactivate select lines. A conductive channel through each inactivate supply switch 140 (e.g. the source-drain channel of the TFT), when opened, electrically connects the reference voltage line 165 to the supply line 110 and all the sensor pixels 100 connected to that supply line 110.

Each supply line 110 is connected to the supply voltage line 175 via an activate supply switch 145. Each activate supply switch 145 is also connected to one of the activate select lines. The sensor 10 is configured to selectively open/close each activate supply switch 145 by selectively applying an electrical signal to the activate select line to which said activate supply switch 145 is connected (thereby to selectively set the supply line 110 to V_{DD}). A control terminal of each activate supply switch 145 (e.g. a gate region of the TFT) is connected to one of the activate select lines. A conductive channel through each activate supply switch 145 (e.g. the source-drain channel of the TFT), when opened, electrically connects the supply voltage line 175 to the supply line 110 and all the sensor pixels 100 connected to that supply line 110.

Each read-out line 120 is connected to both the inactivate connection circuitry 160 and the activate connection circuitry 170. Each read-out line 120 is connected to the reference voltage line 165 via an inactivate read-out switch 150. Each inactivate read-out switch 150 is also connected to one of the inactivate select lines. The sensor 10 is configured to selectively open/close each inactivate read-out switch 150 by selectively applying an electrical signal to the inactivate select line to which said inactivate read-out switch 150 is connected (thereby to selectively set the read-out line 120 to V_{COM}). A control terminal of each inactivate read-out switch 150 (e.g. a gate region of the TFT) is connected to one of the inactivate select lines. A conductive channel through each inactivate read-out switch 150 (e.g. the source-drain channel of the TFT), when opened, electrically connects the reference voltage line 165 to the read-out line 120 and all the sensor pixels 100 connected to that read-out line 120.

Each read-out line 120 is connected to the read-out connection channel 125 via an activate read-out switch 155. The read-out connection channel 125 is connected to a processing channel of the read-out circuitry of the sensor 10. Each activate read-out switch 155 is also connected to one of the activate select lines. The sensor 10 is configured to selectively open/close each activate read-out switch 155 by selectively applying an electrical signal to the activate select line to which said activate read-out switch 155 is connected (thereby to selectively connect the read-out line 120 to the read-out connection channel 125). A control terminal of each activate read-out switch 155 (e.g. a gate region of the TFT) is connected to one of the activate select lines. A conductive channel through each activate read-out switch 155 (e.g. the source-drain channel of the TFT), when opened, electrically connects the read-out line 120 and all the sensor pixels 100 connected to that read-out line 120 to the read-out connection channel 125.

The sensor 10 is configured to multiplex read-out signals from the sensor pixels 100 so that a plurality of read-out lines 120 may each be connectable to the same single read-out processing channel of the read-out processing circuitry of the sensor 10. The sensor 10 is configured to multiplex these connections so that no more than one read-out line 120 will be connected to each single read-out processing channel of the read-out processing circuitry at any one time. The read-out lines 120 may be provided in different groups, where each group of read-out lines 120 is associated with a single processing channel of the read-out processing circuitry. In other words, for each group, the read-out lines 120 in that group may each be connected to the same read-out processing channel. For each group of read-out lines 120, the sensor 10 is configured to only connect one read-out line 120 in that group to the associated read-out processing channel for that group at any one time. The other read-out line(s) 120 in that group will not be connected to said read-out processing channel at that time.

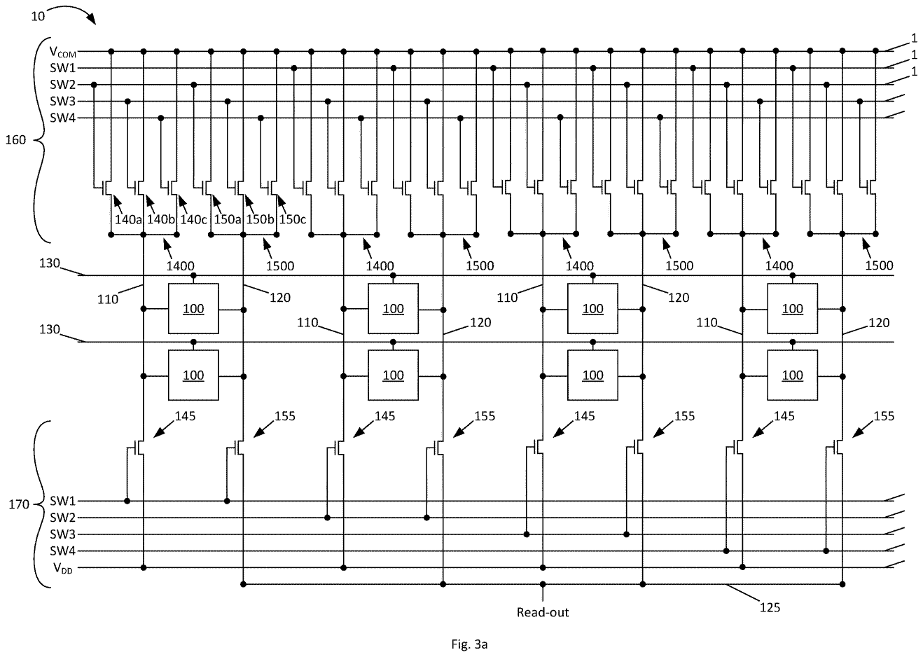

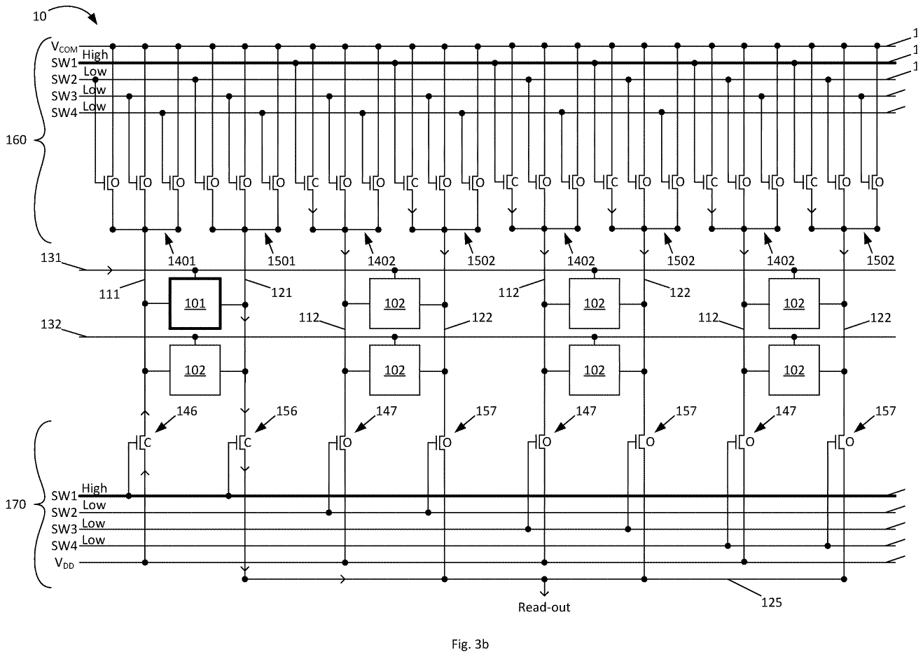

Each group of read-out lines 120 may contain two or more read-out lines 120 (as well as the two or more respective supply lines 110 associated with those read-out lines 120). For the example of FIGS. 2a and 2b, there are two read-out lines per group (and for FIGS. 3a and 3b described below, there are four read-out lines per group).

FIG. 2a shows two groups, each containing two read-out lines 120 and the two supply lines 110 associated with those read-out lines 120. Each group contains a respective read-out connection channel 125 which is connected to the processing channel of the read-out processing circuitry. Each read-out line 120 in the group is selectively connectable to said read-out connection channel 125 for that group. Each group is therefore associated with two columns of sensor pixels 100. Hereinafter, the columns of sensor pixels 100 will be referred to as “first column” for the column on the left, and “second column” for the column on the right. The sensor 10 is configured to operate with one column connected to the reference voltage line 165 and the other column connected to the supply voltage line 175 and read-out connection channel 125.

For each column of sensor pixels 100, the inactivate supply switch 140 and the inactivate read-out switch 150 are connected to the same conductive line. Likewise, for each column of sensor pixels 100, the activate supply switch 145 and the activate read-out switch 155 are connected to the same conductive line. The first column of sensor pixels 100 has its inactivate switches connected to the second inactivate select line 162. The first column of sensor pixels 100 has its activate switches connect to the first activate select line 171. The first inactivate select line 161 and the first activate select line 171 may be provided by the same conductive line or they may be separate conductive lines. If provided by separate conductive lines, the two conductive lines may be connected to a common source (e.g. a common voltage source). The second column of sensor pixels 100 has its inactivate switches connected to the first inactivate select line 161. The second column of sensor pixels 100 has its activate switches connect to the second activate select line 172. Again, the second activate select line 172 and the second inactivate select line 162 may be provided by the same line or separate lines.

The sensor 10 is configured to control application of electrical signals to the conductive lines of the inactivate connection circuitry 160 and the activate connection circuitry 170 to selectively open/close the inactivate switches and the activate switches. The sensor 10 is configured to control operation so that, for each group of columns of sensor pixels 100, one column in the group has its supply line 110 connected to the supply voltage (V_{DD}) and its read-out line 120 connected to the read-out connection channel 125 (and thus to the processing channel of the read-out processing circuitry). The sensor 10 is configured to control operation so that the other column(s) in that group (which is one column in the example of FIG. 2a) have their read-out line(s) 120 and supply line(s) 110 connected to the reference voltage (V_{COM}).

To activate a column of sensor pixels 100, the sensor 10 is configured to apply an electrical signal to the inactivate select line and the activate select line associated with that column of sensor pixels 100. For the first column, the associated lines are the first inactivate select line 161 and the first activate select line 171. By applying the electrical signal to the first inactivate select line 161 and the first activate select line 171, the first column of sensor pixels 110 will be activated and the second column of sensor pixels 110 will be inactivated. For the second column, the associated lines are the second inactivate select line 162 and the second activate select line 172. By applying the electrical signal to the second inactivate select line 162 and the second activate select line 172, the second column of sensor pixels 110 will be activated and the first column of sensor pixels 110 will be inactivated.

The inactivate switches for the supply line 110 and read-out for each column are connected to the inactivate select line associated with the other column in the group. As shown in FIG. 2a, the inactivate supply switch 140 and the inactivate read-out switch 150 for the first column of sensor pixels 100 are connected to the second inactivate select line 162. Likewise, the inactivate supply switch 140 and the inactivate read-out switch 150 for the second column of sensor pixels 100 are connected to the first inactivate select line 161. The activate switches for the supply line 110 and read-out for each column are connected to the activate select line associated with that column. As shown in FIG. 2a, the activate supply switch 145 and the activate read-out switch 155 for the first column of sensor pixels 100 are connected to the first activate select line 171. Likewise, the activate supply switch 145 and the activate read-out switch 155 for the second column of sensor pixels 100 are connected to the second activate select line 172.

Each of the activate and inactivate switches is configured to close (and thus permit conduction therethrough) in response to an electrical signal being applied to the activate/inactivate select line to which that switch is connected. The sensor 10 is configured to apply a voltage to the activate/inactivate select lines to cause the switches connected thereto to close. The sensor 10 is configured so that electrical signals (e.g. a voltage) will be applied to either: (i) the first inactivate select line 161 and the first activate select line 171, or (ii) the second inactivate select line 162 and the second activate select line 172, at any one time.

The inactivate connection circuitry 160 and the activate connection circuitry 170 of the sensor 10 are arranged so that application of an electrical signal to both the first inactivate select line 161 and the first activate select line 171 will activate the first column of sensor pixels 100 in each group. This will also inactivate the remaining columns in the group (i.e. the second columns in FIG. 2a). Likewise, application of an electrical signal to the second activate and inactivate select line will activate the second column of sensor pixels 100 and inactivate the first column.

For instance, by applying the electrical signal to the first inactivate select line 161, e.g. by driving the first inactivate select line 161 to a high voltage (and not the second inactivate select line 162), this will close the inactivate supply switch 140 and the inactivate read-out switch 150 for the second column of sensor pixels 100, while leaving the corresponding switches for the first column of sensor pixels 100 open. In so doing, the supply line 110 and read-out line 120 for the second column will be connected to the reference voltage line 165 (and thus maintained at the reference voltage V_{COM}). The corresponding switches for the first column will be open, and so the supply line 110 and the read-out line 120 for the first column will not be connected to the reference voltage line 165.

By applying the electrical signal to the first activate select line 171, e.g. by driving the first activate select line 171 to a high voltage (and not the second inactivate select line 162), this will close the activate supply switch 145 and the activate read-out switch 155 for the first column of sensor pixels 100, while leaving the corresponding switches for the second column of sensor pixels 100 open. In so doing, the supply line 110 for the first column will be connected to the supply voltage line 175 (and thus charged to the supply voltage V_{DD}), and the read-out line 120 for the first column will be connected to the read-out connection channel 125 (and thus to the processing channel of the read-out processing circuitry of the sensor 10). The corresponding switches for the second column will be open, and so the supply line 110 and the read-out line 120 for the second column will not be connected to the supply voltage line 175 and read-out connection channel 125, respectively.

The opposite will occur when applying the electrical signal to the second inactivate and activate select lines, e.g. by driving said lines to a high voltage (and not the first inactivate and activate select lines).

As with the example of FIGS. 1a and 1b, the sensor 10 is configured to apply scanning signals to a scan line 130 of the array for activating sensor pixels 100 in that row (where the activated sensor pixels 100 in that row are those which are also in activated columns). Those activated sensor pixels 100 will be activated by the scanning signal, will receive the supply voltage (V_{DD}) and a read-out signal therefrom will be provided to the read-out connection channel 125 and to the read-out processing channel of the processing circuitry of the sensor 10.

An example operation of the sensor 10 of FIG. 2a will now be described with reference to FIG. 2b. Thick black lines are used to indicate which of the sensor pixels 100 are activated, and to which of the select lines the electrical signal is applied (e.g. which of the select lines are driven to a high voltage). For each of the switches, an accompanying “O” or “C” is shown to illustrate whether those switches are open (non-conducting) or closed (conducting). Arrows are also used to show the direction of current flow through the sensor 10.

FIG. 2b shows the sensor 10 of FIG. 2a with two activated sensor pixels 101. The remaining sensor pixels are inactivated sensor pixels 102. The activated scan line 131 is in the second row of sensor pixels, and the remaining scan lines are inactivated scan lines 132.

As shown, electrical signals are applied to the first inactivate select line 161 and the first activate select line 171 (but not to the second inactivate select line 162 and the second activate select line 172). For this, each of the first lines may be driven to a high voltage (while the second lines are at a low, e.g. zero, or a negative voltage). The two first lines are shown as “SW1”, as they closed a first series of switches (for activating the first column), and the two second lines are shown as “SW2”, as they close a second series of switches (for activating the second column).

With the electrical signal applied to the first inactivate select line 161 (e.g. with the first inactive select line 161 driven to a high voltage), the second and fourth columns of sensor pixels have closed inactivate supply switches 141 and closed inactivate read-out switches 151. These closed switches are thus electrically conductive and connect their respective supply/read-out lines to the reference voltage line 165. Those lines are therefore held at the reference voltage V_{COM}. These are shown as inactivated supply lines 112 and inactivated read-out lines 122. Conversely, the first and third columns of sensor pixels have open inactivate supply switches 142 and open inactivate read-out switches 152. These switches are not electrically conductive and so their respective supply/read-out lines are not connected to the reference voltage.

With the electrical signal applied to the first activate select line 171 (e.g. with the line 171 driven to a high voltage), the first and third columns of sensor pixels have closed activate supply switches 146 and closed activate read-out switches 156. These closed switches are thus electrically conductive. The closed activate supply switches connect their respective supply lines to the supply voltage line 175. Those lines are therefore held at the supply voltage V_{DD}. These are shown as activated supply lines 111. The closed activate read-out switches connect their respective read-out lines to the read-out connection channel 125 (and thus to the processing channel of the read-out processing circuitry). These are shown as activated read-out lines 121. Conversely, the second and fourth columns of sensor pixels have open activate supply switches 147 and open inactivate read-out switches 157. These switches are not electrically conductive and so their respective supply/read-out lines are not connected to the supply voltage/read-out circuitry.

The sensor pixels 101 in the second row and first third columns are therefore activated. The remaining sensor pixels 102 are inactivated. Current may flow from the supply voltage line 175 to the sensor pixels in the first and third columns. The activated sensor pixels 101 in those columns (those in the second row) will then output read-out signals to their respective read-out lines, and those read-out signals are provided to a respective read-out processing channel of the read-out circuitry. Capacitive measurements may therefore be obtained for those activated sensor pixels 101.

The inactivated supply lines 112 and the inactivated read-out lines 122 are held at the reference voltage V_{COM}. The reference voltage V_{COM} may be selected to be the same as a voltage of the read-out processing circuitry of the sensor 10 (or a voltage close thereto, such as within a threshold range of that voltage). The activated read-out lines 121 may therefore be at the same voltage as (or a similar voltage to) the reference voltage V_{COM}. Thus, there may be minimal capacitive coupling between each activated read-out line 121 and any inactivated lines close thereto (e.g. between each activated read-out line 121 and its adjacent inactivated supply line 112). In turn, this may reduce an amount of noise present in read-out signals from activated sensor pixels 101.

In the example shown in FIG. 2b, the sensor 10 is operated to obtain read-out signals from the sensor pixels in the first and third columns in the second row. It will be appreciated that by varying the scan line to which scanning signals are applied and/or by applying the electrical signals (e.g. driving a high voltage) to the second activate/inactivate select lines (instead of the first lines), all of the different sensor pixels in the array may be activated. For example, by driving the second activate/inactivate select lines to a high voltage, it will be sensor pixels in the second and fourth columns which are activated, and by varying the activated scan line 131, it will be pixels in different rows which are activated.

Another example of a capacitive sensor will now be described with reference to FIGS. 3a and 3b. FIG. 3a shows a capacitive sensor 10. The sensor 10 of FIG. 3a is similar to that of FIG. 2a, except that for the sensor 10 of FIG. 3a, each processing channel of the read-out processing circuitry is associated with a group of four read-out lines (and associated supply lines), rather than two, as shown in FIG. 2a. As such, the portion of the sensor array shown in FIG. 3a contains only one such group of read-out/supply lines.

As with FIG. 2a, the sensor 10 of FIG. 3a includes inactivate connection circuitry 160 and activate connection circuitry 170. The inactivate connection circuitry 160 is for connecting the supply and read-out lines of inactivated columns to the reference voltage (V_{COM}), and the activate connection circuitry 170 is for connecting the supply and read-out lines of activated columns to the supply voltage (V_{DD}) and the processing channel of the read-out processing circuitry, respectively. Each of the inactivate connection circuitry 160 and the activate connection circuitry 170 is formed of a plurality of conductive lines and associated switches, with the circuitry arranged so that the application of electrical signals to each of the different conductive lines will close different respective switches.

The sensor 10 of FIG. 3a is arranged so that while each column of sensor pixels 100 in the group is activated, the other (three) columns in the group will be inactivated. In other words, the sensor 10 is configured to connect the supply line for one column in the group to the supply voltage (V_{DD}), while the remaining columns in the group will have their supply lines connected to the reference voltage (V_{COM}). Likewise, the sensor 10 is configured to connect the read-out line for that one column in the group to the read-out connection channel 125, while the remaining columns in the group will have their read-out lines connected to the reference voltage (V_{COM}).

The inactivate connection circuitry 160 includes a plurality of conductive lines and a plurality of associated switches. The inactivate circuitry comprises a first inactivate select line 161, a second inactivate select line 162, a third inactivate select line 163, a fourth inactivate select line 164 and a reference voltage line 165 (for connection to the reference voltage V_{COM}). Each supply line 110 has an associated inactivate supply switch assembly 1400 formed of a plurality of inactivate supply switches 140a, 140b, 140c. The number of inactivate supply switches corresponds to (is one fewer than) the number of columns per group. In the example of FIG. 3a, there are three inactivate supply switches in each inactivate supply switch assembly 1400. Each read-out line 120 has an associated inactivate read-out switch assembly 1500 formed of a plurality of inactivate read-out switches 150a, 150b, 150c. The number of inactivate read-out switches corresponds to (is one fewer than) the number of columns per group. In the example of FIG. 3a, there are three inactivate read-out switches in each inactivate read-out switch assembly 1500.

The activate connection circuitry 170 is formed of a plurality of conductive lines and a plurality of associated switches. The activate connection circuitry 170 comprises a first activate select line 171, a second activate select line 172, a third activate select line 173, a fourth activate select line 174 and a supply voltage line 175. The activate connection circuitry 170 also comprises an activate supply switch 145 for each supply line 110 and an activate read-out switch 155 for each read-out line 120. The activate connection circuitry 170 comprises a read-out connection channel 125.

As with FIG. 2a, each column of sensor pixels 100 has an associated inactivate select line and an associated activate select line. The first column (and thus first supply line and first read-out line) is associated with the first inactivate select line 161 and the first activate select line 171. The second, third and fourth columns are associated with second, third and fourth select lines respectively. Similar to FIG. 2a, by applying the electrical signal to the first inactivate select line 161 and the first activate select line 171, the first column of sensor pixels 110 will be activated and the second, third and fourth column of sensor pixels 110 will be inactivated. By applying the electrical signal to the second, third or fourth inactivate select lines 162, 163, 164, the corresponding column of sensor pixels 100 will be activated, and the first column of sensor pixels 100 will be inactivated. This association will now be explained in more detail below.

For the inactivate connection circuitry 160, each supply line 110 is connected to a plurality of inactivate supply switches. Each of the inactivate supply switches is arranged to selectively connect its supply line 110 to the reference voltage line 165. Each of said inactivate supply switches is connected to a respective inactivate select line. Each inactivate supply switch is arranged to selectively conduct in response to application of an electrical signal to the inactivate select line to which that switch is connected. For example, each inactivate supply switch may be provided by a transistor, e.g. a TFT, where a gate region of that transistor is connected to the inactivate select line, and where the conduction path through that transistor connects the reference voltage line 165 to the supply line 110.

As set out above, each supply line 110 in the group is connected to a plurality of inactivate supply switches. For each supply line 110, each of those inactivate supply switches is connected to a different inactivate select line. Each supply line 110 is connected to an inactivate supply switch which is connected to each of the inactivate select lines for the group apart from the inactivate select line associated with that supply line 110. In other words, a supply line 110 for the first column in the group will be connected to inactivate supply switches that are connected to each of the second, third and fourth inactivate select lines (but not to the first inactivate select line 161).

The sensor 10 is arranged so that application of an electrical signal to a chosen inactivate select line (which is associated with a chosen supply line) will cause inactivate supply switches connected to the other supply lines in the group to electrically conduct. Each of the supply lines in the group apart from the chosen supply line will be connected to an inactivate supply switch which is associated with the chosen supply line and connected to the chosen inactivate select line (and is thus electrically conducting). The inactivate supply switches connected to said chosen supply line will be open (they will not conduct, as they are not connected to the chosen inactivate select line). In other words, application of an electrical signal to one of the inactivate select lines will cause all of the supply lines in that group, apart from the supply line associated with said one of the inactivate select lines, to be connected to the reference voltage line 165. The supply line associated with said inactivate select line will not be connected to the reference voltage line 165.

A similar arrangement is provided for each read-out line 120 and the inactivate connection circuitry 160. That is, each read-out line 120 is connected to a plurality of inactivate read-out switches. Each of the inactivate read-out switches is arranged to selectively connect its read-out line 120 to the reference voltage line 165. Each of said inactivate read-out switches is connected to a respective inactivate select line. Each inactivate read-out switch is arranged to selectively conduct in response to application of an electrical signal to the inactivate select line to which that switch is connected. For example, each inactivate read-out switch may be provided by a transistor, e.g. a TFT, where a gate region of that transistor is connected to the inactivate select line, and where the conduction path through that transistor connects the reference voltage line 165 to the read-out line 120.

As set out above, each read-out line 120 in the group is connected to a plurality of inactivate read-out switches. For each read-out line 120, each of those inactivate read-out switches is connected to a different inactivate select line. Each read-out line 120 is connected to an inactivate read-out switch which is connected to each of the inactivate select lines for the group apart from the inactivate select line associated with that read-out line 120. In other words, a read-out line 120 for the first column in the group will be connected to inactivate read-out switches that are connected to each of the second, third and fourth inactivate select lines (but not to the first inactivate select line 161).

The sensor 10 is arranged so that application of an electrical signal to a chosen inactivate select line (which is associated with a chosen read-out line) will cause inactivate read-out switches connected to the other read-out lines in the group to electrically conduct. Each of the read-out lines in the group apart from the chosen read-out line will be connected to an inactivate read-out switch which is associated with the chosen read-out line and connected to the chosen inactivate select line (and is thus electrically conducting). The inactivate read-out switches connected to said chosen read-out line will be open (they will not conduct, as they are not connected to the chosen inactivate select line). In other words, application of an electrical signal to one of the inactivate select lines will cause all of the read-out lines in that group, apart from the read-out line associated with said one of the inactivate select lines, to be connected to the reference voltage line 165. The read-out line associated with said inactivate select line will not be connected to the reference voltage line 165.

For example, as shown in FIG. 3a, the inactivate supply switch assembly for the first supply line is formed of inactivate supply switches 140a, 140b and 140c. The inactivate supply switch 140a is connected to the second inactivate select line 162, the inactivate supply switch 140b is connected to the third inactivate select line, and the inactivate supply switch 140c is connected to the fourth inactivate select line. Application of an electrical signal to the second, third or fourth inactivate select lines will cause the respective one of the inactivate supply switches 140a, 140b and 140c to electrically conduct, thereby connecting the first supply line to the reference voltage line 165 (and thus charge the first supply line to V_{COM}). Application of an electrical signal to the first inactivate select line 161 will not cause any of the inactivate supply switches 140a, 140b and 140c to close, and so will not cause the first supply line to be connected to the reference voltage line 165.

Likewise, as shown in FIG. 3a, the inactivate read-out switch assembly for the first read-out line is formed of inactivate read-out switches 150a, 150b and 150c. The inactivate read-out switch 150a is connected to the second inactivate select line 162, the inactivate read-out switch 150b is connected to the third inactivate select line, and the inactivate read-out switch 150c is connected to the fourth inactivate select line. Application of an electrical signal to the second, third or fourth inactivate select lines will cause the respective one of the inactivate read-out switches 150a, 150b and 150c to electrically conduct, thereby connecting the first read-out line to the reference voltage line 165 (and thus charge the first read-out line to V_{COM}). Application of an electrical signal to the first inactivate select line 161 will not cause any of the inactivate read-out switches 150a, 150b and 150c to close, and so will not cause the first read-out line to be connected to the reference voltage line 165.

For the activate connection circuitry 170, each supply line is connected to an activate supply switch. Each activate supply switch is arranged to selectively connect its supply line to the supply voltage line 175. Each activate supply switch is connected to the activate select line associated with the supply line to which that activate supply switch is connected. Each activate supply switch is arranged to selectively conduct in response to application of an electrical signal to the activate select line to which that switch is connected. For example, each activate supply switch may be provided by a transistor, e.g. a TFT, where a gate region of that transistor is connected to the activate select line, and where the conduction path through that transistor connects the supply voltage line 175 to the supply line.

In other words, the sensor 10 is arranged so that application of an electrical signal to a chosen activate select line (which is associated with a chosen supply line) will cause the activate supply switch connected to the chosen supply line to electrically conduct. The chosen supply line will be connected to an activate supply switch which is electrically conducting and will thus be connected to the supply voltage line 175. The other supply lines in the group will not be connected to the supply voltage line 175, as they will each be connected to an activate supply switch which is not connected to the chosen activate select line.

Each read-out line is connected to an activate read-out switch. Each activate read-out switch is arranged to selectively connect its read-out line to the read-out connection channel 125. Each of the read-out lines in the group are selectively connectable to said read-out connection channel 125. Each activate read-out switch is connected to the activate select line associated with the read-out line to which that activate read-out switch is connected. Each activate read-out switch is arranged to selectively conduct in response to application of an electrical signal to the activate select line to which that switch is connected. For example, each activate read-out switch may be provided by a transistor, e.g. a TFT, where a gate region of that transistor is connected to the activate select line, and where the conduction path through that transistor connects the supply line to the read-out connection channel 125.

In other words, the sensor 10 is arranged so that application of an electrical signal to a chosen activate select line (which is associated with a chosen read-out line) will cause the activate read-out switch connected to the chosen read-out line to electrically conduct. The chosen read-out line will be connected to an activate read-out switch which is electrically conducting and will thus be connected to the read-out connection channel 125. The other read-out lines in the group will not be connected to the read-out connection, as they will each be connected to an activate read-out switch which is not connected to the chosen activate select line.

The sensor 10 is configured to control operation so that, at any one time, one column of sensor pixels 100 in the group is activated and the remaining columns in the group are inactivated. The supply line for the activated column in the group will be connected to the supply voltage line 175, and the read-out line for the activated column in the group will be connected to the read-out connection channel 125. For each of the inactivated columns in the group, the supply lines for those inactivated columns will be connected to the reference voltage line 165, and the read-out lines for those inactivated columns will be connected to the reference voltage line 165.

The inactivate connection circuitry 160 is configured to selectively connect all but one of the columns in the group to the reference voltage line 165. The supply lines and the read-out lines for those columns in the group will therefore be at the reference voltage V_{COM}. The activate connection circuitry 170 is configured to selectively connect the one column in the group (which is not connected to the reference voltage line 165) for obtaining read-out signals. For this, the supply line for that column is connected to the supply voltage line 175 and the read-out line for that column is connected to the read-out connection channel 125.

The sensor 10 is configured to selectively apply electrical signals to the different activate and inactivate select lines in order to select which of the sensor pixels 100 in the array are activated. The sensor 10 is configured so that applying an electrical signal to one activate select line, and the corresponding inactivate select line, will activate the column associated with those two select lines and inactivate all of the other columns in the group. In other words, application of a select signal to a first activate select line 171 and a first inactivate select line 161 will cause the first column of sensor pixels 100 to be activated, and the other columns in the group to be inactivated.

Example operation of the sensor 10 of FIG. 3a will now be described with reference to FIG. 3b.

FIG. 3b shows the sensor 10 of FIG. 3a with a select signal being applied to both the first inactivate select line 161 and the first activate select line 171 (e.g. the select lines are driven to a high voltage, as indicated by the thick line in FIG. 3b). As a result, all of the inactivate switches in the first column will be open. This is shown as open supply switch assembly 1401 and open read-out switch assembly 1501. For each of the other columns, each switch assembly will have one closed switch, which is the switch connected to the first inactivate select line 161. These are shown as closed supply switch assembly 1402 and closed read-out switch assembly 1502. For the activate connection circuitry 170, the activate switches in the first column will be closed (shown as closed activate supply switch 146 and closed activate read-out switch 156), and the activate switches in the other columns will be open (shown as open activate supply switch 147 and open activate read-out switch 157).

In FIG. 3b, a scanning signal is applied to the first scan line. This is shown as the activated scan line 131 (and the other scan line shown is an inactivated scan line 132). Electrical signals are applied to the first inactivate select line 161 and the first activate select line 171 (e.g. the lines are driven to a high voltage), and so the supply line for the first column is connected to the supply voltage line 175 and the read-out line for the first column is connected to the read-out connection channel 125. Each of the other columns has their supply and read-out lines connected to the reference voltage line 165. As such, the supply line for the first column in the group will be charged to the supply voltage V_{DD} and the supply line for the other columns in the group will be charged to V_{COM}, as will the read-out lines for the other columns in the group. As shown in FIG. 3b, the first column has an activated supply line 111 and an activated read-out line 121, and the other columns have inactivated supply lines 112 and inactivated read-out lines 122.

It will be appreciated in the context of the present disclosure that the examples described herein should not be considered limiting, and that the underlying technology may be implemented in a number of alternative ways. For example, different switching arrangements may be provided to those shown in the figures. For instance, the switching arrangements described utilise thin film transistors which become electrically conductive by application of a positive voltage (above the switch-on voltage for the transistor) to a gate region of the TFT. However, this switching functionality could be implemented in other ways, such as using different types of transistors, e.g. where different signals are applied to open/close the switch. For instance, in such cases, application of a select signal to a select line may not involve driving that line to a higher voltage (than the other select lines). Similarly, the sensor array has been described as being provided by a plurality of rows of sensor pixels and a plurality of columns of sensor pixels, with scan lines spanning across rows, and supply and read-out lines spanning across columns. However, other spatial arrangements for the sensor pixels and conductive lines could be provided. For example, each supply/read-out line need not be associated with every sensor pixel in a column. Instead, each said line could be associated with a plurality of different sensor pixels distributed across the sensor array. Each sensor pixel may be connected to one supply line, read-out line and scan line, but the arrangement of that sensor pixel and those conductive lines should not be considered limiting.

In examples described herein, the sensor is a capacitive sensor, such as a capacitive touch sensor. However, the present disclosure may also be implemented with other forms of sensor. For example, rather than each sensor pixel having a capacitive sensing electrode, each sensor pixel may instead have another sensor element configured to provide sensing of a relevant parameter. For example, each sensor pixel may comprise an optical sensor element configured to provide optical sensing (e.g. X-ray, gamma ray, visible light etc.). Such sensors may be provided by an active-matrix sensor array, and may still benefit from fixing inactivated supply/read-out lines to a reference voltage. Similarly, a few example sensor pixel designs have been described herein, but these should not be considered limiting. Each sensor pixel may be configured to output a read-out signal to a read-out line indicative of a charge on its capacitive sensing electrode in response to application of a scanning signal to a scan line connected to that sensor pixel and a supply voltage to a supply line connected to that sensor pixel. Any suitable pixel design may be provided for this functionality. For example, each sensor pixel may comprise one or more TFTs, wherein the TFT(s) of the sensor pixel are arranged to output a read-out signal indicative of charge stored on the capacitive sensing electrode. For example, a TFT may output a current to the read-out line, where that current is proportional to the charge on the capacitive sensing electrode, and where that current will only be output when the sensor pixel also receives the scanning signal and supply voltage. For example, a conduction channel through the TFT may provide a selective and variable connection between the supply line and read-out line, where that connection is influenced by the capacitive sensing electrode (and where the scan signal acts to cause that TFT to conduct).

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. In addition the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example, method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Other examples and variations of the disclosure will be apparent to the skilled addressee in the context of the present disclosure.

1. A capacitive sensor comprising:
a plurality of read-out lines; and
an array of sensor pixels, wherein each sensor pixel is connected to a read-out line and comprises a capacitive sensing electrode;
wherein the sensor is configured to:
obtain, from a first read-out line, a signal indicative of a charge on the capacitive sensing electrode of at least one sensor pixel connected to said first read-out line; and
maintain a second read-out line at a read-out reference voltage while obtaining said signal from the first read-out line.

2. A capacitive sensor comprising:
a plurality of supply lines; and
an array of sensor pixels, wherein each sensor pixel is connected to a supply line and comprises a capacitive sensing electrode;
wherein the sensor is configured to:
obtain a signal indicative of a charge on the capacitive sensing electrode of at least one sensor pixel connected to a first supply line; and
maintain a second supply line at a supply reference voltage while obtaining said signal from said at least one sensor pixel connected to the first supply line.

3. The sensor of claim 1, wherein:
the sensor comprises a plurality of supply lines and each sensor pixel is connected to a supply line;
the at least one sensor pixel connected to the first read-out line is connected to a first supply line; and
the sensor is configured to maintain a second supply line at a supply reference voltage while obtaining the signal from the first read-out line.

4. The sensor of claim 3, wherein the supply reference voltage is the same as the read-out reference voltage and wherein each read-out line has a corresponding supply line connected to the same sensor pixels as said read-out line.

5. (canceled)

6. The sensor of claim 1, wherein the first read-out line and the second read-out line are switchably connected to a single channel of read-out circuitry of the sensor, wherein three or more read-out lines are switchably connected to a single channel of read-out circuitry of the sensor, and wherein the sensor is configured to multiplex signals from said two or more read-out lines onto the single channel.

7. (canceled)

8. The sensor of claim 1, wherein the sensor is configured to selectively connect each read-out line to either: (i) a read-out reference voltage source for maintaining said read-out line at the read-out reference voltage, or (ii) read-out circuitry of the sensor for processing signals received therefrom.

9. The sensor of claim 2, wherein the sensor is configured to selectively connect each supply line to either: (i) a supply reference voltage source for maintaining said supply line at the supply reference voltage, or (ii) a pixel supply voltage source for providing electrical energy to sensor pixels connected to said supply line.

10. The sensor of claim 3, further comprising a plurality of select lines, wherein each select line is associated with a read-out line and a corresponding supply line; and
wherein the sensor is configured to control application of select signals to each select line to control connections of the read-out line and supply line associated with said select line.

11. The sensor of claim 10,
wherein the sensor is configured to selectively connect each read-out line to either: (i) a read-out reference voltage source for maintaining said read-out line at the read-out reference voltage, or (ii) read-out circuitry of the sensor for processing signals received therefrom; and
wherein the sensor is configured to selectively connect each supply line to either: (i) a supply reference voltage source for maintaining said supply line at the supply reference voltage, or (ii) a pixel supply voltage source for providing electrical energy to sensor pixels connected to said supply line; and
wherein applying a select signal to a select line associated with the first read-out line and the first supply line connects: (i) the first read-out line to the read-out circuitry, and (ii) the first supply line to the pixel supply voltage source.

12. The sensor of claim 10,
wherein the sensor is configured to selectively connect each read-out line to either: (i) a read-out reference voltage source for maintaining said read-out line at the read-out reference voltage, or (ii) read-out circuitry of the sensor for processing signals received therefrom; and
wherein the sensor is configured to selectively connect each supply line to either: (i) a supply reference voltage source for maintaining said supply line at the supply reference voltage, or (ii) a pixel supply voltage source for providing electrical energy to sensor pixels connected to said supply line; and
wherein applying a select signal to a select line associated with the second read-out line and the second supply line connects: (i) the second read-out line to the read-out reference voltage source, and (ii) the second supply line to the supply reference voltage source.

13. The sensor of claim 1, wherein the first read-out line is adjacent to the second read-out line.

14. The sensor of claim 2, wherein the first supply line is adjacent to the second supply line.

15. The sensor of claim 1, wherein the read-out reference voltage is selected to correspond to a voltage of read-out circuitry of the sensor, and wherein the read-out reference voltage is the same as or close to the voltage of the read-out circuitry.

16. The sensor of claim 1, wherein the read-out reference voltage for the second line is the same as a voltage for the first read-out line.

17. The sensor of claim 1, wherein the sensor array comprises a plurality of scan lines, wherein each sensor pixel is connected to a scan line for receiving scanning signals.

18-19. (canceled)

20. A method of operating a capacitive sensor, wherein the sensor comprises: (i) a plurality of read-out lines, (ii) a plurality of supply lines, and (iii) an array of sensor pixels, wherein each sensor pixel is connected to a read-out line and a supply line and comprises a capacitive sensing electrode, the method comprising:
obtaining, from a first read-out line, a signal indicative of a charge on the capacitive sensing electrode of at least one sensor pixel connected to said first read-out line and a first supply line;
maintaining a second read-out line at a read-out reference voltage while obtaining said signal from the first read-out line; and
maintaining a second supply line at a supply reference voltage while obtaining said signal from the first read-out line.

21. The method of claim 18 or 20, further comprising connecting the first read-out line to read-out circuitry and connecting the second read-out line to a read-out reference voltage source, and
connecting the first supply line to a pixel supply voltage source and the second supply line to a supply reference voltage source.

22. (canceled)

23. The method of claim 21, wherein connecting both: (i) the second read-out line to the read-out reference voltage source, and (ii) the second supply line to the supply reference voltage source, comprises connecting the second read-out line and the second supply line to the same reference voltage source.

24. The method of claim 20, wherein the method comprises controlling application of select signals to a plurality of select lines to control connections of the read-out lines and/or the supply lines.

25. A computer program product comprising computer program instructions configured to program a capacitive sensor to implement the method of claim 20.
